(19) United States
(12) Patent Application Publication
(10) Pub. No.: US 2011/0293246 A1
(43) Pub. Date: Dec. 1, 2011

(54) SYSTEMS AND METHODS OF MANAGING NETWORK VIDEO RECORDING SYSTEMS

(75) Inventors: Shanmugam Selvarajan, Bangalore (IN); Marine Drive, Bangalore (IN); Mayur S. Salgar, Bangalore (IN); NarayanaMurthy Subramanya J., Bangalore (IN)

(73) Assignee: Honeywell International Inc., Morristown, NJ (US)

(21) Appl. No.: 12/791,126

(22) Filed: Jun. 1, 2010

(51) Int. Cl. H04N 5/93; G06F 3/01

(52) U.S. Cl. 386/278; 715/719; 386/E05.001

(57) ABSTRACT

A system and method for managing a network video recording system are provided. The method includes interfacing a network video recording system with an end user operating system, and managing the network video recording system via the end user operating system.

### FIELD OF INVENTION

The present invention relates generally to network video recording systems. More particularly, the present invention relates to systems and methods of managing network video recording systems.

### BACKGROUND

Known network video recording (NVR) systems include a custom storage system with video data stream management and storage concealed in a file system. Thus, known network video recording systems require a proprietary installation before use and can only be managed via custom monitoring and storage management tools. However, proprietary installations are often impractical for novice or entry level users.

There is thus a continuing, ongoing need for improved systems and methods to manage network video recording systems. Preferably, such systems and methods enable a user to manage a network video recording system using his or her everyday operating system.

### BRIEF DESCRIPTION OF THE DRAWINGS

FIG. 1 is a flow diagram of a method of managing a network video recording system in accordance with the present invention;

FIG. 2 is a block diagram of a system for carrying out methods in accordance with the present invention;

FIG. 3 is an interactive window displayed on a viewing screen of a graphical user interface for storing, naming, and organizing a network video recording system in accordance with the present invention;

FIG. 4 is an interactive window displayed on a viewing screen of a graphical user interface for sorting a network video recording system in accordance with the present invention;

FIG. 5 is an interactive window displayed on a viewing screen of a graphical user interface for browsing a network video recording system in accordance with the present invention;

FIG. 6 is an interactive window displayed on a viewing screen of a graphical user interface for searching a network video recording system in accordance with the present invention;

FIG. 7 is an interactive window displayed on a viewing screen of a graphical user interface for viewing video data streams associated with a network video recording system in accordance with the present invention;

FIG. 8 is an interactive window displayed on a viewing screen of a graphical user interface for configuring a network video recording system in accordance with the present invention;

FIG. 9 is an interactive window displayed on a viewing screen of a graphical user interface for analyzing the configuration of a network video recording system in accordance with the present invention; and

FIG. 10 is an interactive window displayed on a viewing screen of a graphical user interface for graphically analyzing the configuration of a network video recording system in accordance with the present invention.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include improved systems and methods to manage network video recording systems. Preferably, such systems and methods enable a user to manage a network video recording system using his or her everyday operating system.

Systems and methods in accordance with the present invention can enable a user to interface with a network video recording system via his or her personal computer. The personal computer can be connected to the Internet, an intranet, a LAN, or a server, as would be known by those of skill in the art, so that programs, data, and files can be downloaded and/or accessed from the network video recording system on the user's personal computer.

An everyday operating system running on a user's personal computer can support systems and methods in accordance with the present invention. For example, Microsoft Windows® is an operating system that can be run on a personal computer and that supports many different types of programs. In embodiments of the present invention, a user can interface with Microsoft Windows® and its programs to manage a network video recording system.

Embodiments of the present invention will be described herein with respect to the operating system, Microsoft Windows and its associated programs. However, it is to be understood that the present invention can be used in connection with other types of operating systems both known and not yet known.

In embodiments of the present invention, files associated with a network video recording system can be stored, named, and organized as all other files supported by a user's everyday operating system. For example, using a Microsoft Windows operating system, all files and video data streams can be named as would be known by those of skill in the art, and stored and organized using folders and sub-folders known to Microsoft Windows® users.

Further, files associated with the network video recording system can be moved between folders of the operating system for reorganization. For example, using a Microsoft Windows® operating system, files can be cut and paste from one storage location or folder to another storage location or folder.

In embodiments of the present invention, files associated with a network video recording system can be searched. For example, a Microsoft Windows operating system supports a search tool, and all files can be searched based on date, time, camera number, event details, or any other metadata associated with the file.

Video data streams associated with the network video recording system can be opened and played in a media player supported by a user's operating system. Further, video data streams can be shared between users via the Internet, an intranet, a LAN, or a web/streaming server.

Some embodiments of the present invention include systems and methods for analyzing and graphically analyzing the configuration of a network video recording system. For example, a Microsoft Windows® operating system can support an Excel® program. A user can specify configuration details for the network video recording system in Excel®, either online or offline, and import the configuration details to the network video recording system. When troubleshooting the network video recording system, a user can send an Excel® spreadsheet to a technician for analyzing the configuration of the system.

A user can also audit a network video recording system using an operating system of a personal computer. For example, a user can generate charts and reports via Microsoft Excel®.

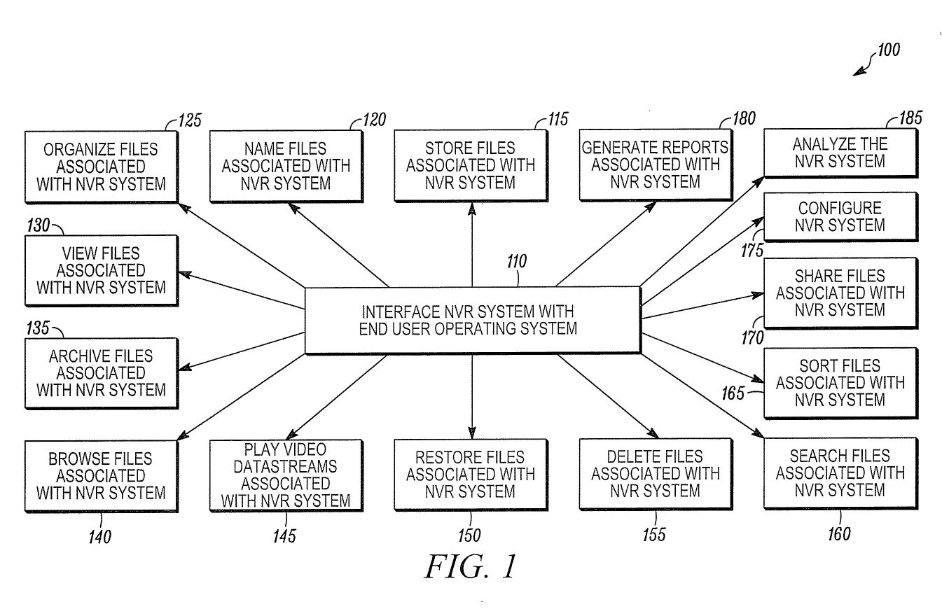

FIG. 1 is a flow diagram of a method 100 of managing a network video recording system in accordance with the present invention. In the method 100, a network video recording system can be interfaced with an end user's operating system as in 110. In embodiments of the present invention, the network video recording system can interface with the end user's operating system via the Internet, an intranet, a server, or in any other manner as would be known by those of skill in the art.

Once the network video recording system has interfaced with the end user's operating system, the method 100 can manage the network video recording system by executing any of the following: storing files associated with the network video recording system as in 115, naming files associated with the network video recording system as in 120, organizing files associated with the network video recording system as in 125, viewing files associated with the network video recording system as in 130, archiving files to the network video recording system as in 135, browsing files associated with the network video recording system 140, playing video data streams associated with the network video recording system as in 145, restoring files associated with the network video recording system as in 150, deleting files associated with the network video recording system as in 155, searching files associated with the network video recording system as in 160, sorting files associated with the network video recording system as in 165, sharing files associated with the network video recording system as in 170, configuring the network video recording system as in 175, generate reports associated with the network video recording system as in 180, and analyze the network video recording system as in 185.

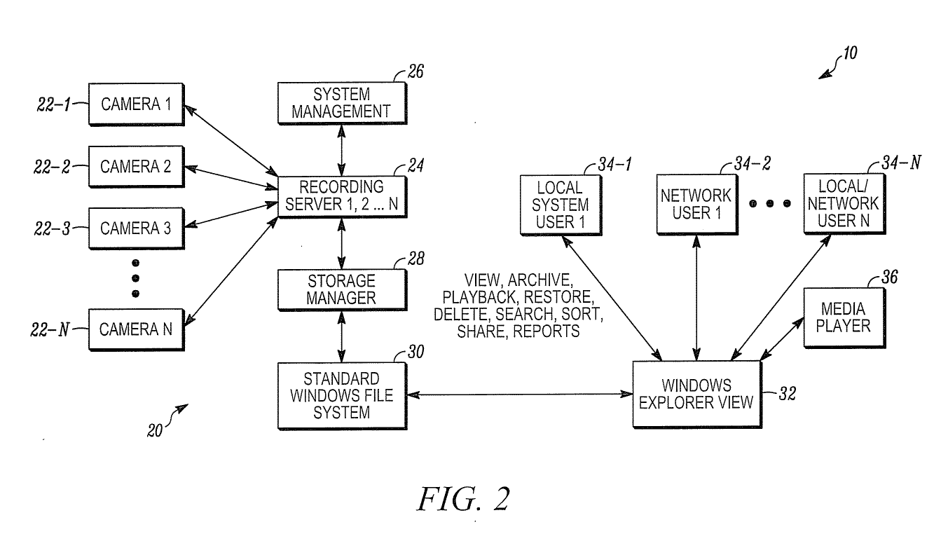

The method shown in FIG. 1 and others in accordance with the present invention can be implemented with the exemplary system 10 seen in FIG. 2. The network video recording system 20 can include a plurality of cameras 22-1, 22-2, 22-3, . . . 22-N monitoring a surveillance area. Each of the cameras can be associated with a recording server 24, which can be in communication with a system management module 26 and a store manager module 28.

The network video recording system 20 can interface with and/or be associated with an operating system, such as Microsoft Windows® 30, which can support a Windows® Explorer view 32. A plurality of local users 34-1, 34-2, . . . 34-N can interface with the Explorer view 32 for managing the network video recording system 20 in accordance with the present invention. A media player 36 as would be known by those of skill in the art can also interface with the Explorer view 32 for playing video data streams associated with the plurality of cameras 22-1, 22-2-22-3, . . . 22-N.

The elements of the system 10 can be implemented with control circuitry, a programmable processor, and software, stored on local computer readable medium, as would be understood by those of skill in the art. Each local user 34-1, 34-2, . . . 34-N can include a personal computer or other workstation known to those of skill in the art. Further, a personal computer or other workstation can include a viewing screen for interfacing with a user. In some embodiments, the viewing screen can be an interactive multi-dimensional graphical user interface.

The interactive and viewing windows shown and described herein are exemplary only. Those of skill in the art will understand that the features of the windows shown and described herein may be displayed by additional or alternate windows.

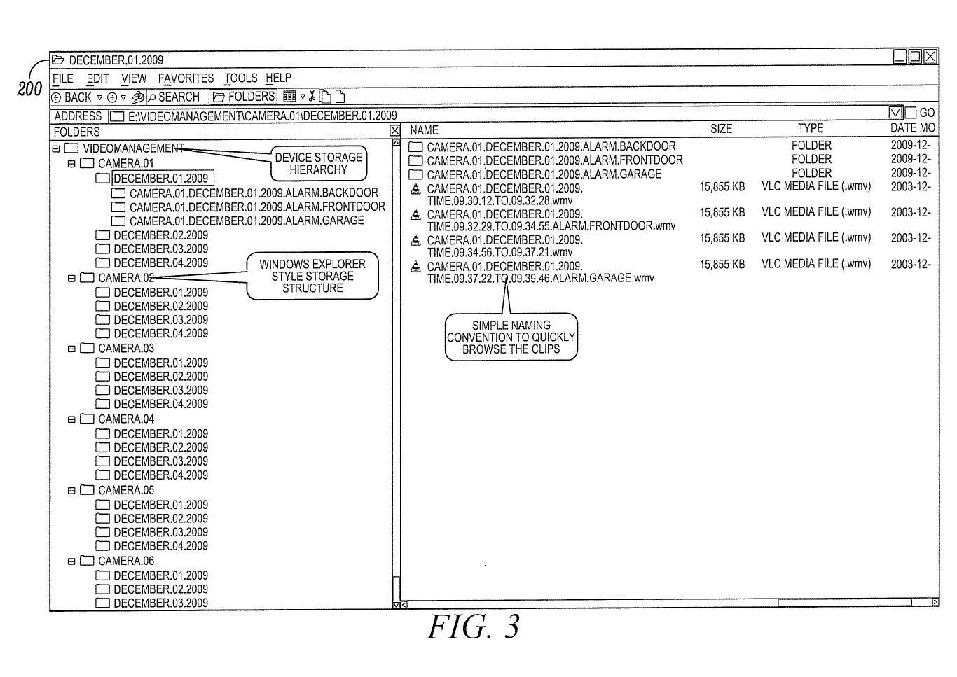

FIG. 3 is an interactive window 200 displayed on a viewing screen of a graphical user interface for storing, naming, and organizing a network video recording system in accordance with the present invention. The exemplary window 200 seen in FIG. 3 is supported by a Microsoft Windows® operating system, and as such, includes a folder-style hierarchy.

The operating system can include a network video recording system folder, with sub-folders for each folder. Each camera sub-folder can include further sub-folders for dates, and each date sub-folder can include files of video data streams associated with the parent date and camera.

The files of video data streams can be named in a conventional manner known to those of ordinary skill in the art. For example, a user can choose the name of each video data stream file so that it is meaningful to the user and easily identifiable. A user can change the name of a file at any time.

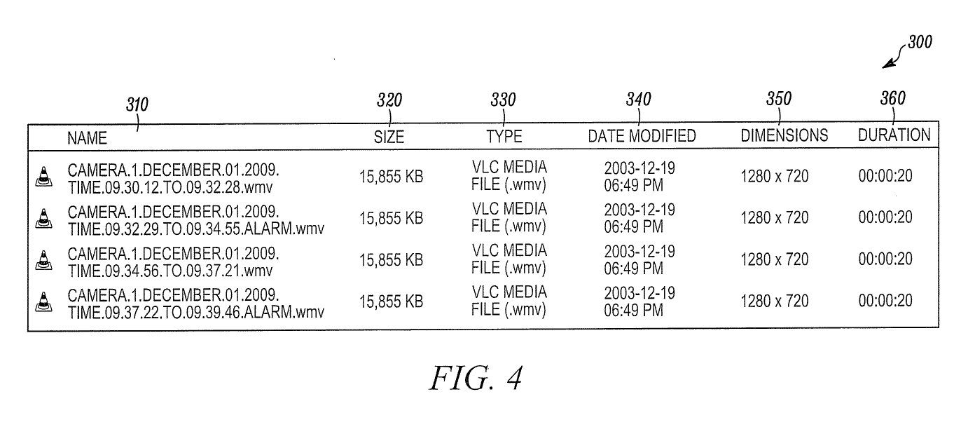

FIG. 4 is an interactive window 300 displayed on a viewing screen of a graphical user interface for sorting a network video recording system in accordance with the present invention. As can be seen in FIG. 4, files associated with the network video recording system can be sorted by, for example, name 310, size 320, type 330, date modified 340, dimensions 350, or duration 360.

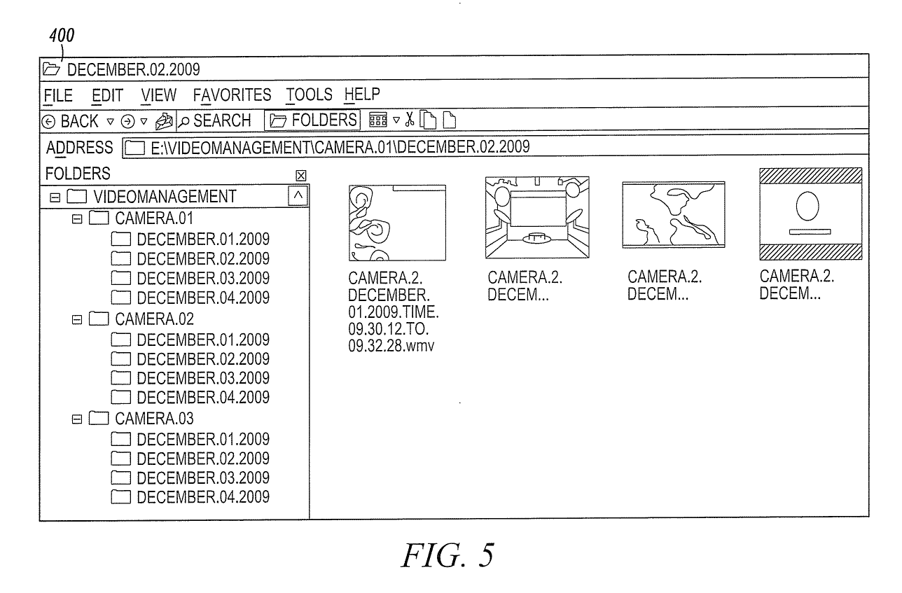

FIG. 5 is an interactive window 400 displayed on a viewing screen of a graphical user interface for browsing a network video recording system in accordance with the present invention. As can be seen in FIG. 5, the window 400 can display thumbnails associated with the files of the network video recording system for quickly browsing through the files.

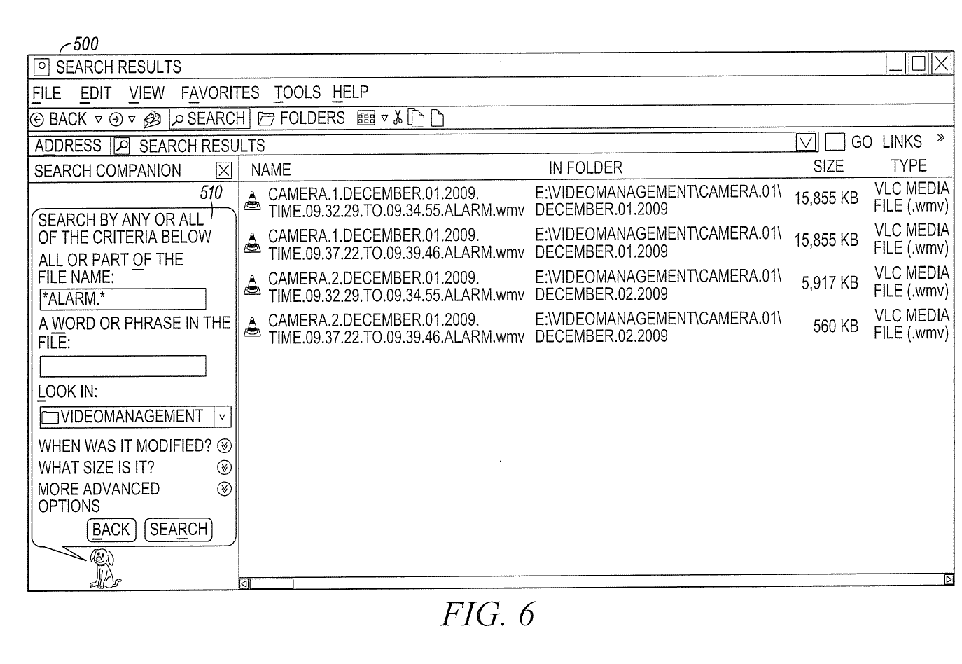

FIG. 6 is an interactive window 500 displayed on a viewing screen of a graphical user interface for searching a network video recording system in accordance with the present invention. Many known operating systems include search features for searching the system. As can be seen in FIG. 6, files associated with a network video recording system can be searched using for, example, a search window 510 associated with, for example, Microsoft Windows®.

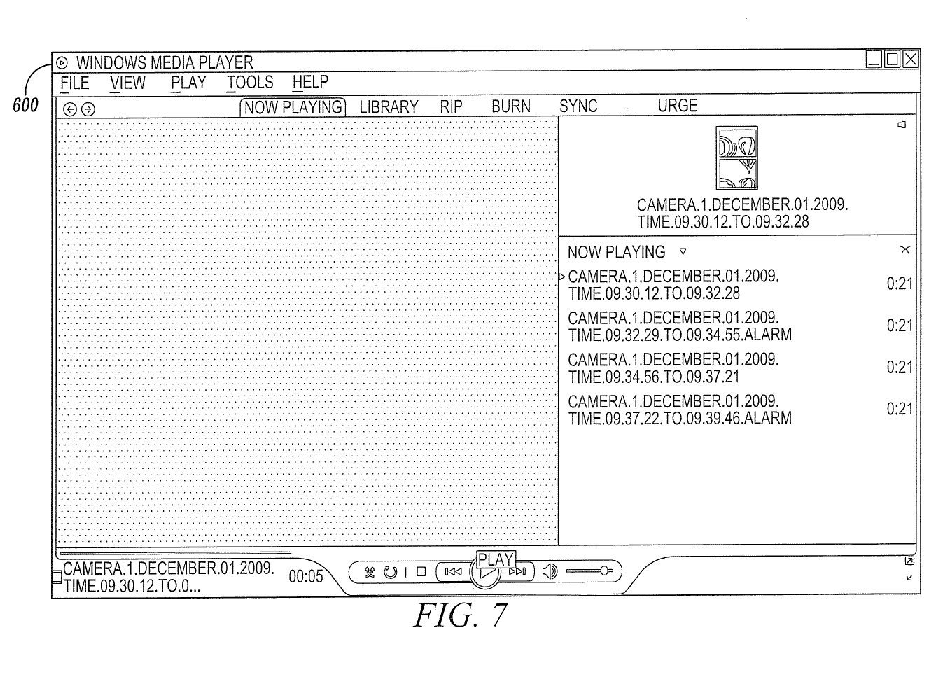

FIG. 7 is an interactive window 600 displayed on a viewing screen of a graphical user interface for viewing video data streams associated with a network video recording system in accordance with the present invention. The window 600 seen in FIG. 7 can support a media player for playing video data streams associated with the network video recording system.

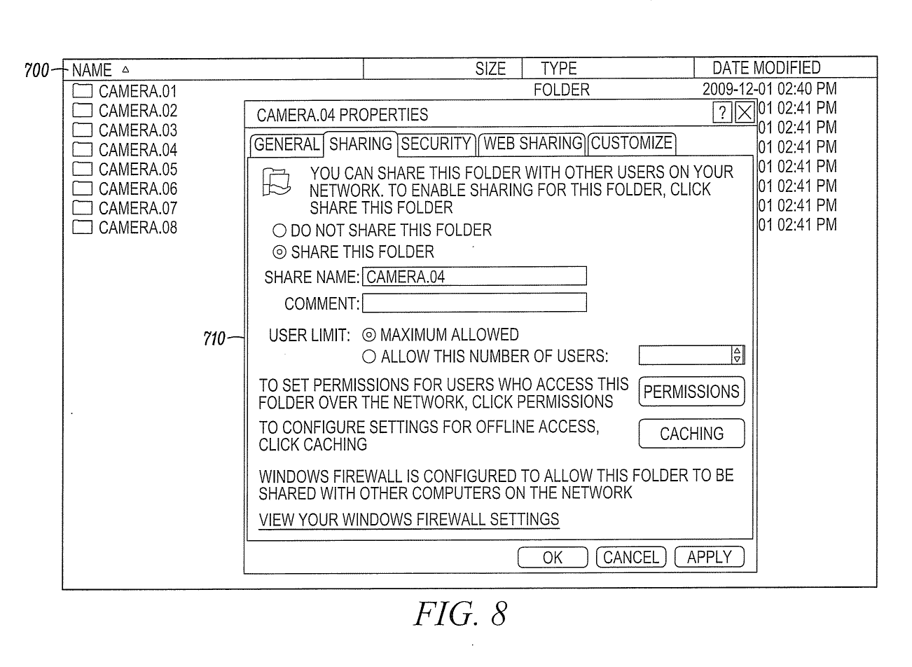

FIG. 8 is an interactive window 700 displayed on a viewing screen of a graphical user interface for configuring a network video recording system in accordance with the present invention. A user can access properties of elements of the network video recording system and configure those properties accordingly. For example, as seen in FIG. 8, a sub-window 710 can be used to configure the properties of Camera 04.

Properties that can be configured include, for example, general properties, sharing properties, security properties, web sharing properties, and customization properties. The web sharing properties of a file or element of the network video recording system can be configured in such a way to enable multiple user to access the file or element via, for example a LAN.

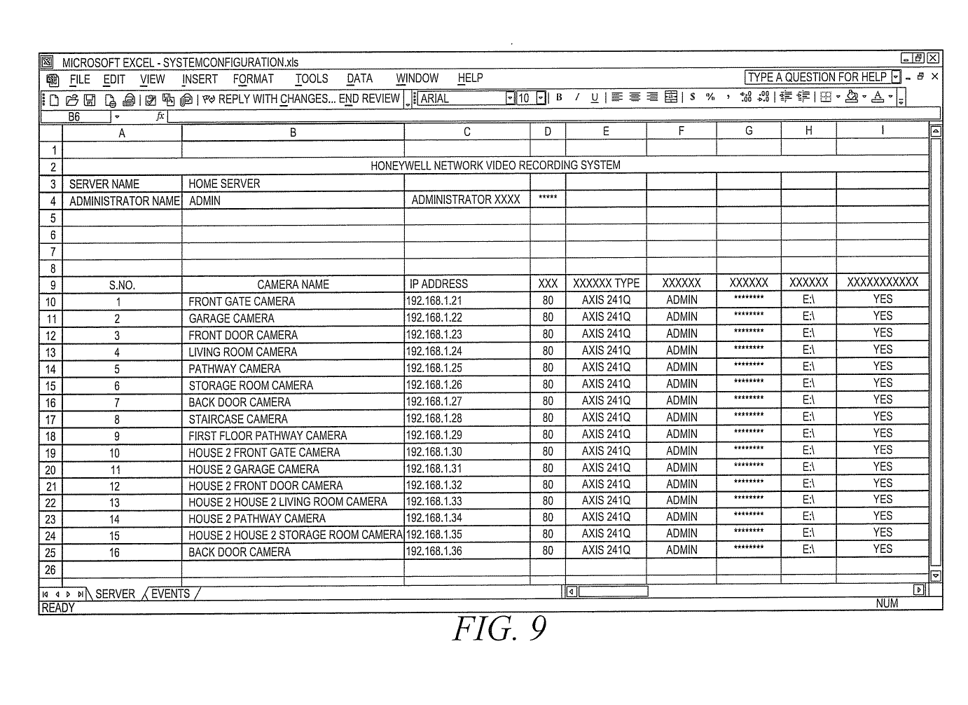

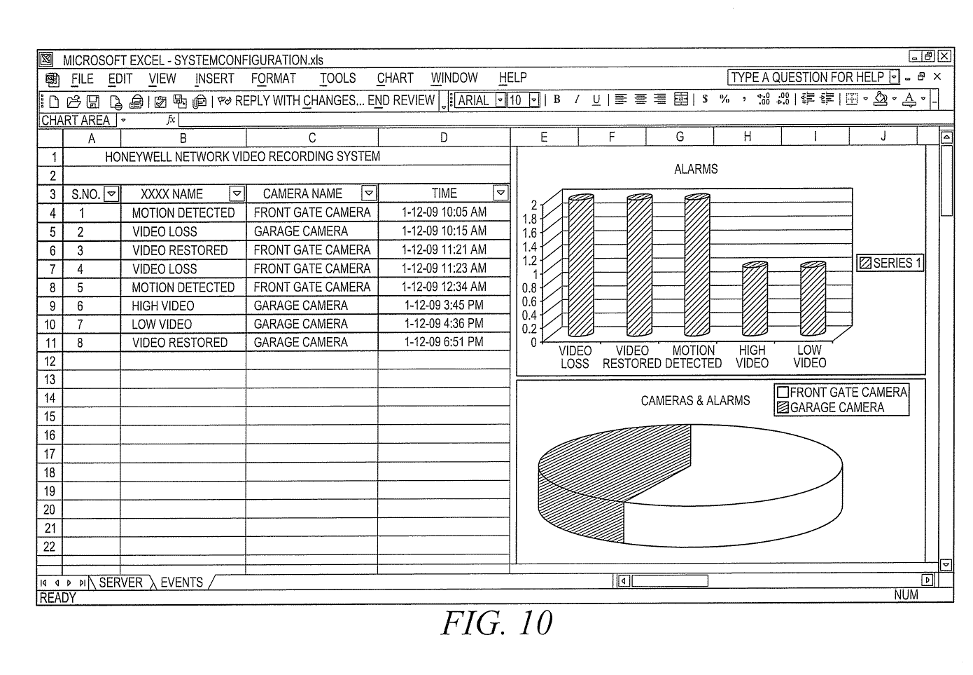

FIG. 9 is an interactive window 800 displayed on a viewing screen of a graphical user interface for analyzing the configuration of a network video recording system in accordance with the present invention, and FIG. 10 is an interactive window displayed on a viewing screen of a graphical user interface for graphically analyzing the configuration of a network video recording system in accordance with the present invention. The operating system, for example, Microsoft Windows®, can support a Microsoft Excel program for analyzing the configuration of the network video recording system.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the sprit and scope of the claims.

What is claimed is:

1. A method comprising:
interfacing a network video recording system with an end user operating system; and
managing the network video recording system via the end user operating system.

2. The method of claim 1 wherein managing the network video recording system via the end user operating system includes naming files associated with the network video recording system.

3. The method of claim 1 wherein managing the network video recording system via the end user operating system includes organizing files associated with the network video recording system.

4. The method of claim 1 wherein managing the network video recording system via the end user operating system includes viewing files associated with the network video recording system.

5. The method of claim 1 wherein managing the network video recording system via the end user operating system includes archiving files associated with the network video recording system.

6. The method of claim 1 wherein managing the network video recording system via the end user operating system includes browsing files associated with the network video recording system.

7. The method of claim 1 wherein managing the network video recording system via the end user operating system includes playing video data streams associated with the network video recording system.

8. The method of claim 1 wherein managing the network video recording system via the end user operating system includes restoring files associated with the network video recording system.

9. The method of claim 1 wherein managing the network video recording system via the end user operating system includes deleting files associated with the network video recording system.

10. The method of claim 1 wherein managing the network video recording system via the end user operating system includes searching files associated with the network video recording system.

11. The method of claim 1 wherein managing the network video recording system via the end user operating system includes sorting files associated with the network video recording system.

12. The method of claim 1 wherein managing the network video recording system via the end user operating system includes sharing files associated with the network video recording system.

13. The method of claim 1 wherein managing the network video recording system via the end user operating system includes configuring the network video recording system via the end user operating system.

14. The method of claim 1 wherein managing the network video recording system via the end user operating system includes generating reports associated with the network video recording system.

15. The method of claim 1 wherein interfacing the network video recording system with the end user operating system includes connecting the network recording system and the end user operating system via one of the Internet, an intranet, a LAN, and a server.

16. The method of claim 1 wherein the end user operating system includes Microsoft Windows®.

17. An apparatus comprising:
circuitry that interfaces a network video recording system with an end user operating system; and
and circuitry for managing the network video recording system via the end user operating system.

18. The apparatus as in claim 17 wherein the end user operating system includes Microsoft Windows®.

19. A system comprising:
a programmable processor and associated control circuitry; and
a user interface coupled to the programmable processor, wherein the user interface accepts user input for managing a network video recording system.

20. The system of claim 19 further comprising a personal computer.
